(19) United States
(12) Patent Application Publication
(10) Pub. No.: US 2018/0218477 A1
(43) Pub. Date: Aug. 2, 2018

(54) DATA INTERPOLATION DEVICE, METHOD THEREFOR, AND IMAGE PROCESSING APPARATUS

(71) Applicant: CANON KABUSHIKI KAISHA, Tokyo (JP)

(72) Inventor: Tadayoshi Nakayama, Tokyo (JP)

(21) Appl. No.: 15/868,883

(22) Filed: Jan. 11, 2018

(30) Foreign Application Priority Data
Jan. 27, 2017 (JP) 2017-013240

(51) Int. Cl. G06T 3/40; G06T 7/11

(52) U.S. Cl. CPC G06T 3/4007; G06T 7/11

(57) ABSTRACT

A device includes a calculation unit configured to calculate difference data up to a predetermined stage with respect to a plurality of reference data, a selection unit configured to select a forward difference parameter from the reference data and the difference data, an adjustment unit configured to adjust the forward difference parameter to segment a corresponding forward step width, and an arithmetic unit configured to determine interpolation data for the plurality of reference data, by performing a forward addition operation based on the adjusted forward difference parameter.

### BACKGROUND OF THE INVENTION

### Field of the Invention

The aspect of the embodiments relates to a data interpolation technology for coordinate conversion in geometrical conversion of an image.

### Description of the Related Art

A correction function corrects gradation of an image, and a geometrical conversion function corrects and transforms a shape of an image. The correction function and the geometrical conversion function can each be approximated by a global function or a local function that uses a coordinate position of an image as a variable. Many of these functions are expressed by a polynomial, or a rational polynomial for conversion such as projective transformation. Even in a case where an approximation can be made using a local function, it is difficult to change the local function at a region boundary, by accurately determining an area to which the local function is to be applied. Therefore, a value obtained by evaluating a local function value at a grid point of a certain pixel spacing is generally held in a look up table (hereinafter abbreviated as LUT). A function value of a grid point read out from this LUT is interpolated and used as a correction value or a transformation value.

It is not necessary to calculate data to be stored in a LUT in real time. Therefore, calculation is performed as accurate as possible, using a high degree polynomial and various functions that may require a complicated operation. In contrast, interpolation processing for data read out from a LUT is to be performed in real time and therefore, in general, linear interpolation is performed as discussed in, for example, Japanese Patent No. 5410232.

Assume that the interpolation is performed using a high degree polynomial to achieve interpolation accuracy higher than the accuracy of linear interpolation. In this case, multiplication and addition are performed many times. Moreover, a coefficient of a polynomial is to be calculated in real time. Therefore, a circuit scale becomes substantially large. Assume that audio equipment is used, in which the frequency band of a signal to be processed is about 1/1000 times the frequency band of a video image. In the case of audio equipment, the devices can be used some-hundred-fold or longer times to process one sample value. Therefore, complicated arithmetic processing can be performed using a single adder and a single multiplier, tens of times, or hundreds of times. In Japanese Patent Application Laid-Open No. 9-89649, polynomial-based interpolation processing such as spline interpolation and Newton interpolation is performed to calculate an acoustic transmission characteristic of a head portion.

In contrast, in a case of video equipment, a pixel rate and an operating frequency of an arithmetic circuit are nearly the same, and the same number of multipliers as the number of multiplications appearing in an arithmetic expression to perform an operation for each pixel is provided. In recent years, a video image of a size of 8K×4K has appeared. In a situation where a pixel rate is higher than an operating frequency of an arithmetic circuit, the arithmetic circuits is driven in parallel, which leads to a further increase in the circuit scale.

In order to increase accuracy of interpolation between grid points of a LUT, an attempt may be made to perform interpolation by using a high degree polynomial. In this case, an arithmetic unit that makes an interpolation polynomial by referring to as much grid point data as possible, and a polynomial calculation unit including a multiplier for calculating the polynomial are provided. Further, in a case where highly accurate geometrical conversion is performed by executing high degree interpolation in real time for all coordinate information representing a two-dimensional image, based on conversion coordinate data stored in a LUT, two-dimensional coordinates in two axial directions is interpolated. This requires four polynomial calculation units, which leads to providing an interpolation processing unit of a substantially large scale.

### SUMMARY OF THE INVENTION

According to an aspect of the embodiments, a device includes a calculation unit configured to calculate difference data up to a predetermined stage with respect to a plurality of reference data, a selection unit configured to select a forward difference parameter from the reference data and the difference data, an adjustment unit configured to adjust the forward difference parameter to segment a corresponding forward step width, and an arithmetic unit configured to determine interpolation data for the plurality of reference data, by performing a forward addition operation based on the forward difference parameter adjusted by the adjustment unit.

Further features of the disclosure will become apparent from the following description of exemplary embodiments with reference to the attached drawings.

### BRIEF DESCRIPTION OF THE DRAWINGS

FIG. 1 is a configuration diagram of a geometrical conversion device.

FIG. 2 is a diagram illustrating a positional relationship of four reference data and an interpolation section.

FIG. 3 is a flowchart illustrating a procedure of an interpolation processing method according to a first exemplary embodiment.

FIGS. 4A and 4B illustrate a configuration of an interpolation processing device and a configuration of a difference calculation unit of the interpolation processing device according to the first exemplary embodiment.

FIGS. 5A and 5B illustrate a configuration of a forward difference adjustment unit and a configuration of a forward addition arithmetic unit, respectively, according to the first exemplary embodiment.

FIG. 6 is a diagram illustrating a configuration of an interpolation processing device according to a second exemplary embodiment.

FIGS. 7A and 7B illustrate a configuration of an interpolation arithmetic unit and a configuration of a polynomial arithmetic unit, respectively, according to a modification of the second exemplary embodiment.

FIGS. 8A, 8B, and 8C illustrate configurations of an interpolation arithmetic unit, a difference calculation unit, and a polynomial arithmetic unit, respectively, according to a third exemplary embodiment.

### DESCRIPTION OF THE EMBODIMENTS

Exemplary embodiments of the disclosure will be described in detail below with reference to the drawings.

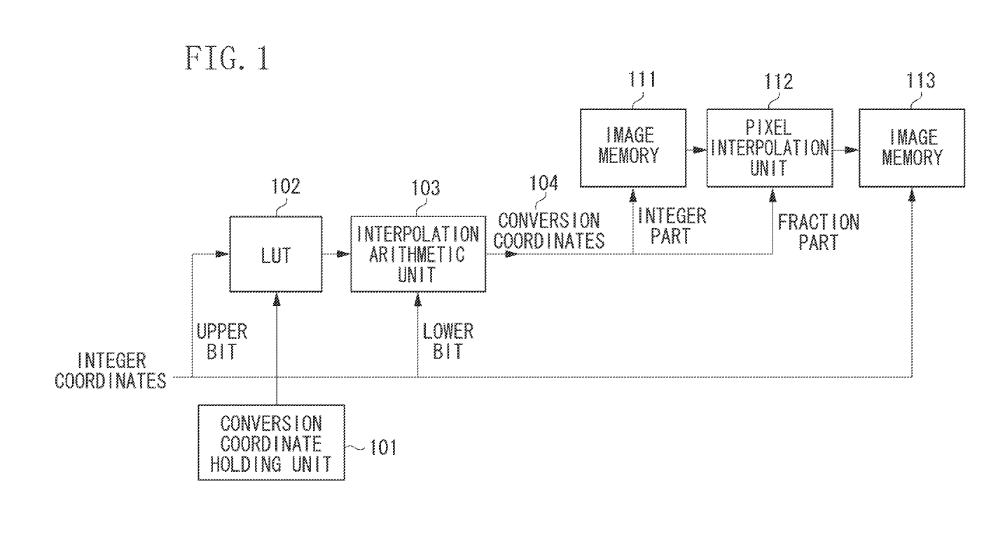

FIG. 1 is a diagram illustrating a configuration of an image processing apparatus that performs geometrical conversion on an image. A conversion coordinate holding unit 101 holds geometrical conversion coordinates corresponding to a specific grid point. A look up table (LUT) 102 serving as a coordinate storage unit stores the geometrical conversion coordinates held in the conversion coordinate holding unit 101. From an upper bit of integer coordinates of an input conversion target pixel, conversion coordinates of grid points before and after the coordinates of a target pixel are determined using the LUT 102. The determined conversion coordinates are interpolated using a lower bit of the integer coordinates of the conversion target pixel to determine the conversion coordinates of the target pixel. From pre-conversion image data stored in an image memory 111 serving as an image storage unit, pixel data corresponding to the integer part of the determined conversion coordinates is read out. The read out pixel data is interpolated by a pixel interpolation unit 112 based on the fraction part of the conversion coordinates. The pixel data obtained by the interpolation is written to the position of the integer coordinates of the conversion target pixel in an image memory 113. Thus, image data resulting from the geometrical conversion is saved in the image memory 113.

In the present exemplary embodiments, discrete geometrical conversion coordinate values stored in the LUT 102 are referred to in an interpolation arithmetic unit 103, and the values are referred to by more than 2×2. A parameter of high degree interpolation is thereby calculated, and a conversion coordinate is generated for each pixel in a coordinate scan direction by high-degree interpolation. Such a data interpolation method will be described below.

There is a technique referred to as a forward difference method, which is effective when the evaluation is continued from sample values obtained by evaluating a polynomial at uniform intervals at the same intervals. The forward difference method can sequentially calculate values of a polynomial for evenly spaced discrete variable values, by performing only an addition operation without performing a multiplication. For example, in Japanese Patent Application Laid-Open No. 2014-142917, to correct an image with high accuracy, a general correction polynomial is defined for the entire image, and the correction polynomial can be adjusted for each line according to the use status of an apparatus. An image correction amount is approximated by the correction polynomial using a coordinate as a variable. Further, an initial value of an operation in the forward difference method is calculated based on the adjusted correction polynomial, and the same value as that calculated by the correction polynomial is sequentially calculated by performing only an addition operation. However, since an interpolation operation is not performed, this operation cannot be used for general interpolation processing. To define terms to be used in the present specification, an outline of this technique will be described.

From evenly spaced n+1 pieces of reference data, first, second, . . . , and nth differences are calculated, and the leading data of the reference data and each of the differences is taken out. A Newton interpolation polynomial is formed by using the data as a coefficient. Where n is a positive integer (e.g., 0, 1, 2, etc.). When 0 to n are each substituted for a variable of the polynomial, the original n+1 pieces of reference data are reproduced. Therefore, the polynomial passes through all the reference data.

In the forward difference method, if there is one set of a series of data on the start point side of reference data and each of differences (hereinafter referred to as “forward difference parameter”), an addition, which is reverse to a subtraction used to generate the relevant parameter, is performed one after another (hereinafter referred to as “forward addition operation”). The original reference data can be thereby reproduced. In this process, it is possible to calculate discrete values of an interpolation polynomial sequentially at uniform intervals, without performing any multiplication. There is a similar technique referred to as a backward difference method, but this technique will not be described here. From the exemplary embodiments, a person skilled in the art can readily understand that the above-described idea is applicable not only to the forward difference method, but also similarly to the backward difference method.

Further, as a related important technology, “adaptive forward difference method” can be cited, which is known as a curve rendering technology. In the adaptive forward difference method, the interval of operation coordinates in a forward difference operation can be finely segmented. For example, Japanese Patent No. 2741033 discusses a technology for rendering a parametric curve. According to this document, in calculating discrete coordinates in a curve, in order to adapt the interval of the coordinate values to a rendering resolution, the parameter of a forward difference operation is appropriately adjusted.

A method for segmenting the interval of operation coordinates used here is effective as a technology for adjusting an interval in continuously performing an interpolation operation for geometrical conversion coordinates. However, coordinate information excluding the start point and the endpoint of a parametric curve does not represent the coordinates of a point through which a curve passes. This coordinate information represents the coordinates of a control point for controlling the shape of a curve. Therefore, a flow for generating rendering coordinates from the coordinate information is greatly different from coordinate interpolation in geometry transformation. Accordingly, this curve rendering technology cannot be used for interpolation processing.

In rendering, the coordinates of a curve expressed in a polynomial is finely generated, according to a resolution (dot per inch (DPI)) of a display device. Therefore, the forward step of the above-described forward difference parameter is appropriately adjusted to an optimum value.

More specifically, if a distance between coordinates is one dot or more, generated curvilinear coordinates are not contiguous and thus, a curve appears faint. Therefore, the forward step is made small such that the inter-coordinate distance becomes one dot or less. However, if the inter-coordinate distance is ½ or less, unnecessarily finely segmented curvilinear coordinates are generated. Therefore, in this case, the forward step is made larger. In this way, in the “forward difference method”, an appropriate adjustment is made such that the inter-coordinate distance becomes ½ dot or more and one dot or less. When the forward step of the forward difference parameter is made small, a third-order parameter is converted using a parameter-segmenting matrix of an expression (1) to be described below. This conversion can halve the forward step. Accordingly, data between the above-described reference data can be interpolated and generated.

Only the expression (1) for segmentation is used for the conversion of the forward difference parameter in the present exemplary embodiments. Conversion by applying the expression (1) repeatedly is made only in a previous stage of a forward addition operation. In contrast, in the rendering, the parameter is also segmented in reverse and therefore, the reverse conversion of the expression (1) is performed as well. Further, the segmentation and the reverse segmentation are performed appropriately in the middle of the forward addition operation. Accordingly, the present exemplary embodiment and the rendering are different in terms of configuration of a forward addition arithmetic unit for performing a coordinate calculation most efficiently. In other words, the way of utilizing the adaptive forward difference method in the present exemplary embodiments is different from the rendering technology.

In following exemplary embodiments, a series of steps for generating an interpolation coordinate string between data pieces from conversion coordinate data read out from a LUT, and a circuit configuration for performing this processing in real time are described.

A first exemplary embodiment will be described below. Coordinate interpolation in geometrical conversion of an image is to be performed for two axes, an x-axis and a y-axis. However, since the interpolation for each axis can be separately performed, the minimum unit for describing an interpolation method can be one axis. Therefore, a method and a device for performing an interpolation operation in one axial direction will be described in detail below. Specifically, a method for sequentially calculating coordinate values will be described, which performs third-order interpolation on a conversion coordinate at a position between middle two grid points among four grid points, by referring to the conversion coordinates of the four grid points arranged at uniform intervals on one axis.

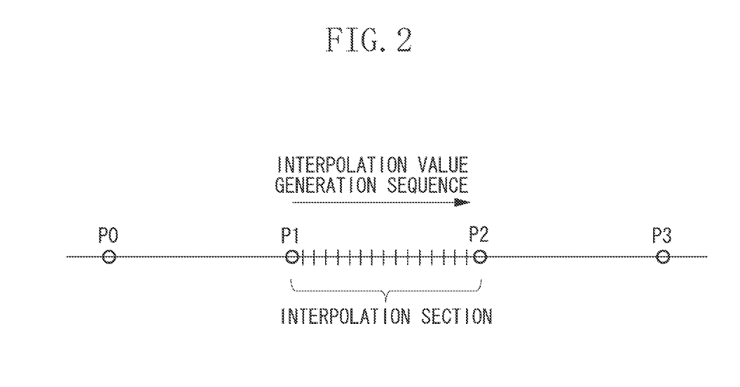

Positions P0, P1, P2, and P3 illustrated in FIG. 2 represent the coordinate positions of pixels arranged at 16-pixel intervals on an image. Coordinate values (x0, y0), (x1, y1), (x2, y2), and (x3, y3) after the respective coordinates are geometrically converted, are held in this order in a LUT. Here, a section to be subjected to coordinate interpolation is a section between the positions P1 and P2. These converted coordinate values are read out from the LUT. The values x0, x1, x2, and x3 are used as one set of reference data corresponding to four points, and the values y0, y1, y2, and y3 are used as another set of reference data. The same interpolation processing is independently performed on each reference data of a total of the two sets. A section to be subjected to the coordinate interpolation is each placed between x1 and x2 and a section between y1 and y2.

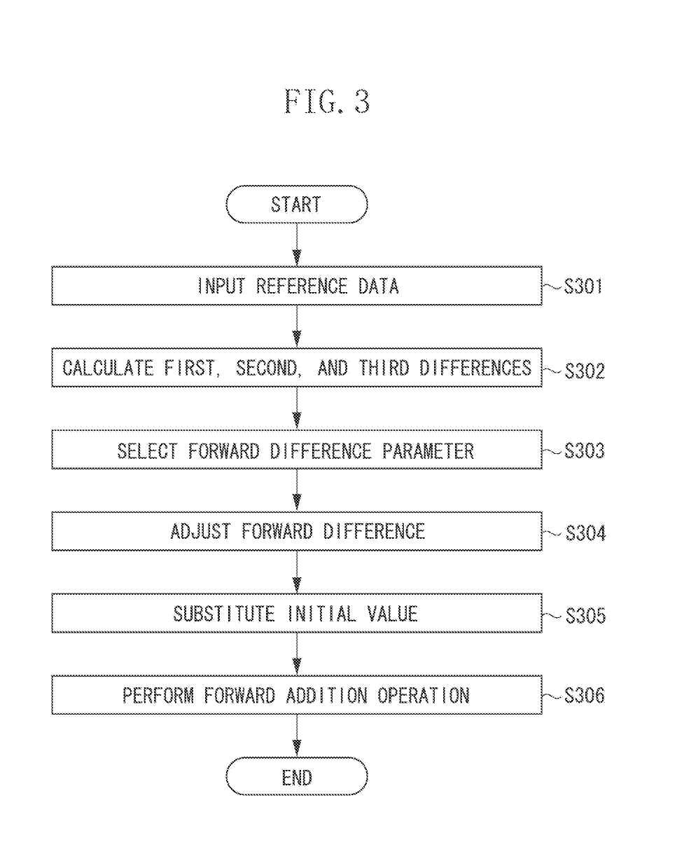

The interpolation processing for the reference data pieces x0, x1, x2, and x3 will be described below with reference to a processing flowchart illustrated in FIG. 3. First, in step S301, the four reference data pieces x0, x1, x2, and x3 are read out from the table holding the converted coordinates, and then substituted for a processing variable.

Next, in step S302, difference data up to a predetermined stage (here, a first difference, a second difference, and a third difference) of the reference data is calculated. When the reference data is a 0-th difference, an m-th difference is obtained by a difference operation between two data pieces of an m-1th difference. More specifically, for the four reference data pieces x0, x1, x2, and x3, three differences x1−x0, x2−x1, and x3−x2 are obtained as a first difference. Further, two differences (x2−x1)−(x1−x0) and (x3−x2)−(x2−x1) are obtained as a second difference. Only difference ((x3−x2)−(x2−x1))−((x2−x1)−(x1−x0)) is obtained as a third difference.

In step S303, one data piece is taken out from the reference data and each of the differences described above, and the taken out data pieces are defined as a forward difference parameter. A typical forward difference parameter discussed in a textbook of mathematics takes an endpoint x0 as be an origin. x0 is taken out from the reference data, (x1−x0) is taken out from the first difference, (x2−x1)−(x1−x0) is taken out from the second difference, and ((x3−x2)−(x2−x1))−((x2−x1)−(x1−x0)) is taken out from the third difference, as the forward difference parameter.

An interpolation value of a target interpolation section can be calculated from the above-described parameters. However, in the present exemplary embodiment, a forward difference parameter taking x1 as an origin is obtained to facilitate the subsequent processing. More specifically, x1 is taken out from the reference data, x2−x1 is taken out from the first difference, and (x3−x2)−(x2−x1) is taken out from the second difference. In a case of employing third-order polynomial interpolation, the third difference remains unchanged whichever reference data is used as an origin. Therefore, the same third difference as the above-described third difference is taken out.

The forward difference parameters can be expressed as [x1, x2−x1, (x3−x2)−(x2−x1), ((x3−x2)−(x2−x1))−((x2−x1)−(x1−x0))]. These parameters have information that can restore the original reference data. A specific example will be described.

The forward difference parameters [x1, x2−x1, (x3−x2)−(x2−x1), ((x3−x2)−(x2−x1))−((x2−x1)−(x1−x0))] are shifted by one. Then, thus obtained [x2−x1, (x3−x2)−(x2−x1), ((x3−x2)−(x2−x1))−((x2−x1)−(x1−x0)), 0] are subjected to a vector addition. Consequently, [x2, x3−x2, 2((x3−x2)−(x2−x1))−((x2−x1)−(x1−x0)), ((x3−x2)−(x2−x1))−((x2−x1)−(x1−x0))] are obtained.

This operation is the same as a forward addition operation to be performed in the last step S306. However, since the forward step is one, the calculation of an interpolation value cannot be accomplished yet. When the forward addition operation is performed once, x1 shifts to x2, and when the forward addition operation is performed once again, x2 shifts to x3. The reference data is thereby restored. Further, as discussed in a textbook of numerical calculation, the above taken out parameter is a coefficient of a Newton forward difference interpolation polynomial. If an interpolation position (a value between 0 and 1) is substituted for a variable of an interpolation polynomial using this coefficient, an interpolation coordinate can be calculated. In the present exemplary embodiment, the same interpolation coordinate as this calculation result is calculated without use of a multiplication operation.

Regarding the parameter taken out in step S303, the forward step is 1. Therefore, an interval for calculating a coordinate is the same as a grid point interval and thus, only a coordinate value for every 16 pixels can be calculated. In other words, if the forward addition operation is performed once as it is, a direct shift from the position P1 to the position P2 in FIG. 2 occurs. Hence, a conversion coordinate at any point in the middle of the interpolation section cannot be obtained at all.

Therefore, in step S304, the forward difference parameter is adjusted by segmentation in such a manner that the forward step of the forward difference parameter is obtained by one pixel of pre-conversion coordinates. A 4×4 matrix of the following expression (1) described in Japanese Patent No. 2741033 is used for this segmentation.

$$[ \begin{matrix}1 & 0 & 0 & 0 \\ 0 & 1 / 2 & - 1 / 8 & 1 / 16 \\ 0 & 0 & 1 / 4 & - 1 / 8 \\ 0 & 0 & 0 & 1 / 8\end{matrix} ] \qquad ( 1 )$$

The forward step can be halved each time the forward difference parameter is converted using the above-described matrix. Therefore, performing the conversion four times makes 16/2̂4=1, i.e., the forward step can be segmented from 16 pixels to one pixel.

In step S305, the parameter after the adjustment, is substituted for an operation variable, as an initial value of a forward addition operation. In step S306, the forward addition operation is repeatedly performed. Here, each time the forward addition operation is performed, the conversion coordinate of a position shifted by one pixel can be obtained. Thus, through the processing flow in FIG. 3, the geometrically converted coordinates at all coordinate positions from the position P1 to the position P2 in FIG. 2 can be obtained using the third-order interpolation.

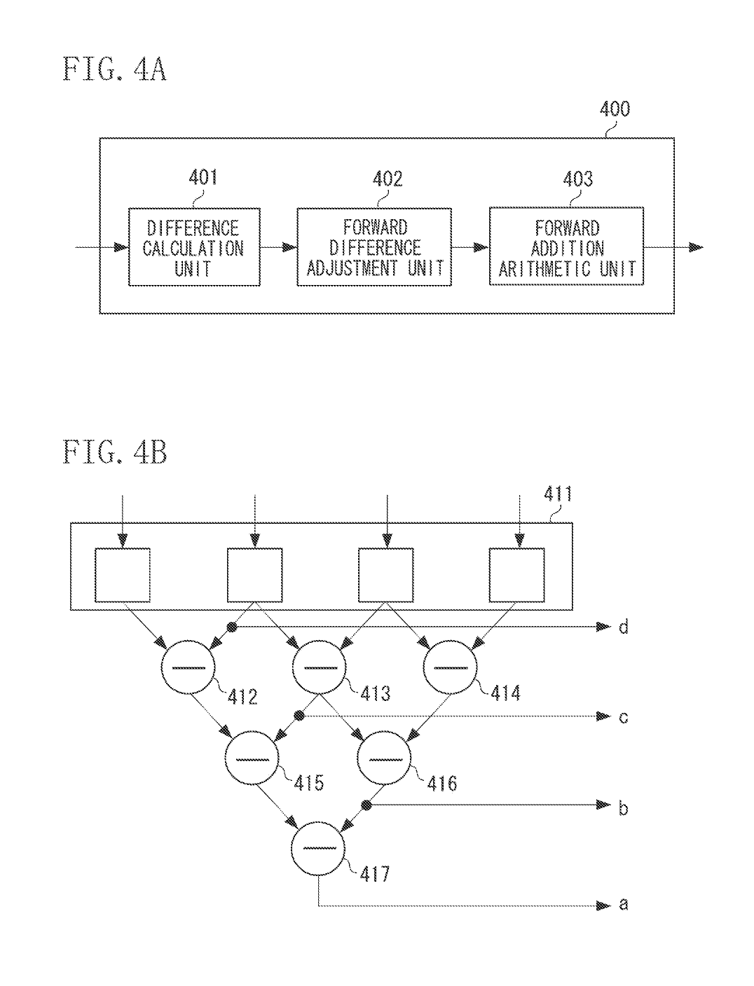

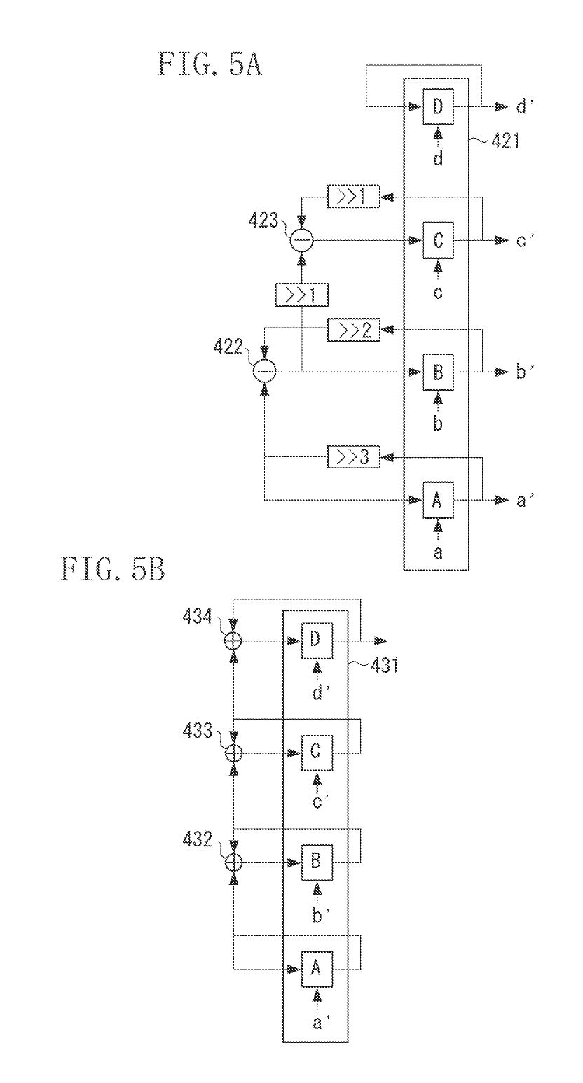

Next, FIG. 4A illustrates an entire configuration of an interpolation operation circuit corresponding to the processing flow in FIG. 3. An interpolation arithmetic unit 400 includes three units, namely, a difference calculation unit 401, a forward difference adjustment unit 402, and a forward addition arithmetic unit 403, which are illustrated in detail in FIG. 4B, FIG. 5A, and FIG. 5B, respectively.

The difference calculation unit 401 illustrated in FIG. 4B holds the four reference data pieces in a register 411. For these reference data pieces, the difference calculation unit 401 calculates three first differences by using subtracters 412, 413, and 414.

For the four reference data pieces x0, x1, x2, and x3, these three subtracters 412, 413, and 414 calculate the first differences x1−x0, x2−x1, and x3−x2, respectively. Next, from these three first differences, the two second differences (x2−x1)−(x1−x0) and (x3−x2)−(x2−x1) are calculated by the subtracters 415 and 416. Finally, from these two second differences, the third difference ((x3−x2)−(x2−x1))−((x2−x1)−(x1−x0)) is calculated with the subtracter 417.

The above reference data, four data pieces of x1, x2−x1, (x3−x2)−(x2−x1), and ((x3−x2)−(x2−x1))−((x2−x1)−(x1−x0)), which are the first difference, the second difference, and the third difference respectively, from the forward difference parameter. This parameter is output from the difference calculation unit 401 to the forward difference adjustment unit 402.

The forward difference adjustment unit 402 reduces the forward step of the parameter from 16 pixels to one pixel, i.e., by 1/16. Therefore, the parameter is converted four times, using the conversion matrix of the above-described expression (1). A circuit illustrated in FIG. 5A is an example of a circuit for repeating the conversion of the expression (1).

The forward difference adjustment unit 402 sets parameters a, b, c, and d input from the difference calculation unit 401, to a register unit 421. Afterward, each time an operation of one cycle is performed, the conversion of the expression (1) is applied, and the forward step is converted into a half. Therefore, if the operation is performed for four cycles, the forward step is segmented from 16 pixels to one pixel, i.e., by 1/16. Initial values a′, b′, c′, and d′ for the subsequent processing, i.e. the forward addition operation, are thereby obtained. The initial values a′, b′, c′, and d′ are output from the forward difference adjustment unit 402 to the forward addition arithmetic unit 403.

The forward addition arithmetic unit 403 performs the forward addition operation in an addition operation circuit illustrated in FIG. 5B, and outputs a geometrically converted coordinate shifted forward by one pixel in every cycle. This output coordinate is the same as interpolation data resulting from third-order interpolation of a total of four reference data pieces including data in an interpolation section and two pieces of data before and after the interpolation section.

The forward difference adjustment unit 402 and the forward addition arithmetic unit 403 are described as separate circuits because the respective functions are different, but these units have similar structures. Therefore, if the register unit is shared and a configuration for switching arithmetic processing depending on the function is provided, a circuit scale can be further reduced. In this case, however, the two functions cannot be simultaneously used and therefore, performance in sequentially calculating interpolation coordinates decreases to some extent. However, no problem arises if this decrease in performance is tolerable when taking account of required performance. Up to here, the interpolation arithmetic unit 400 illustrated in FIG. 4A has been described.

It is easy to expand the interpolation of the present exemplary embodiment to fourth- or higher order interpolation. A method for expanding to n-th order interpolation will be described below.

First, the number of reference data pieces is increased from four to n+1. From the n+1 pieces of reference data, n pieces of first differences are calculated. Afterward, n−1 pieces of second differences, . . . , n+1−i pieces of i-th differences, . . . , and one n-th difference are calculated. The differences are thus calculated. A parameter string of the n+1 pieces of parameters, which takes the reference data at an interpolation starting point as an origin, is the forward difference parameter in this calculation result.

Next, to reduce the forward step width of the n+1 number of forward difference parameters from 16 pixels to 1 pixel, a conversion matrix obtained by expanding the expression (1) to (n+1)×(n+1) is prepared. The forward step is reduced to ½, each time the conversion is performed using this matrix. The forward step is reduced to 1/16, by performing the conversion four times. Up to this operation, the forward difference adjustment is carried out. Afterward, the forward addition operation is repeated, and a geometrical conversion coordinate for each pixel is interpolated and generated in every operation.

According to the present exemplary embodiment, in the coordinate conversion in the geometrical conversion processing of the image, the coordinate interpolation using the n-th order polynomial can be consecutively performed with the adder and the subtracter, without use of a multiplier. Therefore, a highly accurate interpolation operation can be implemented using a small-scale circuit. In particular, in a third-order polynomial which passes through the coordinates of reference four points, a value to be obtained by performing interpolation between middle two points of the reference points by every pixel can be consecutively calculated by addition and subtraction. Therefore, highly accurate interpolation processing can be performed using a circuit of a considerably small scale.

A second exemplary embodiment will be described below. In the first exemplary embodiment, the interpolation operation for four reference data pieces in one axial direction is described. In the second exemplary embodiment, this is expanded to processing in two axial directions, namely, two-dimensional interpolation processing.

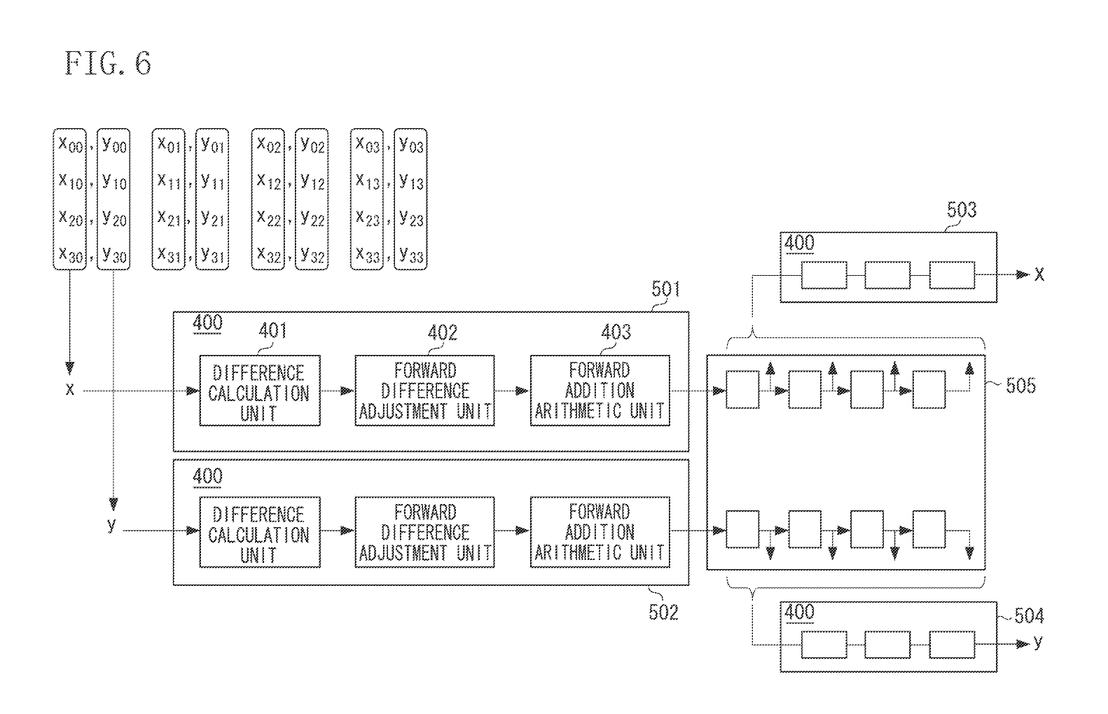

FIG. 6 illustrates a configuration of an interpolation processing device according to the present exemplary embodiment. In this figure, interpolation arithmetic circuits 501 to 504 are each similar to the interpolation arithmetic unit 400 described in the first exemplary embodiment. A register unit 505 is provided to hold intermediate data resulting from interpolation performed in only one axial direction.

FIG. 6 illustrates reference data (xij, yij) (i, j=0, 1, 2, 3) in 4 rows and 4 columns, as input data for completion of the interpolation processing.

Each column of the 4 rows and 4 columns data is divided into four x coordinate data pieces and y coordinate data pieces. These two sets of coordinate data are subjected to the interpolation processing in the two interpolation arithmetic circuits 400 in parallel. Details of this processing are similar to the processing described in the first exemplary embodiment. The interpolation coordinates of interpolation positions defined in a column direction are calculated after a delay of a few to tens of cycles. These interpolation coordinates are sequentially imported into the register unit 505, as the intermediate data. Upon completion of the capture of the intermediate data for the four columns into the register unit 505, the four x data pieces and the four y data pieces are input into the interpolation arithmetic units 503 and 504, respectively, in the next stage.

The interpolation arithmetic units 503 and 504 each perform the interpolation operation for the four input intermediate data. The interpolation arithmetic units 503 and 504 then each calculate an interpolation result for every pixel, namely, an interpolation coordinate of geometrical conversion sequentially, from a second to a third column that is an interpolation section. The reference data may be, typically, two-dimensionally arranged N×M pieces of data where N and M each is a positive integer (e.g. 0, 1, 2, etc.). In this case as well, an area within 2×2 grid points lying at the center is interpolated.

### Modification of Second Exemplary Embodiment

In a case where a scan direction is horizontal, interpolation values are generated continuously in a horizontal direction. However, in a vertical direction, it is not necessary to generate interpolation values continuously, and only an interpolation value is to be calculated. Therefore, an interpolation value is calculated by substituting a forward difference parameter immediately after difference calculation, into a Newton interpolation polynomial. In the present case, an interpolation polynomial represented by an expression (2) is used. This interpolation polynomial is formed by applying Horner's method to a Newton interpolation polynomial. The Horner's method modifies an n-th polynomial to enable calculation of n-times multiplications. As a result, the polynomial represented by the expression (2) is formed.

$$( ( a * \frac{t - 2}{3} + b ) * \frac{t - 1}{2} + c ) * t + d \qquad ( 2 )$$

In this expression, a is a third difference, b is a second difference, c is a first difference, and d is a zero-th difference (reference data). Further, t is an intervening variable that takes 0 at the starting point and 1 at the endpoint of an interpolation section.

The number of pixels located from a pixel position at the starting point to an interpolation pixel position, is divided by 16. The obtained value is normalized and substituted for the variable t. Thus, although a plurality of multipliers may be required, only an interpolation value can be rapidly calculated. It may be also possible to provide only a single multiplier when an operation is sequentially performed from the inside of parentheses in the expression (2). In this case, however, the operation includes a plurality of cycles.

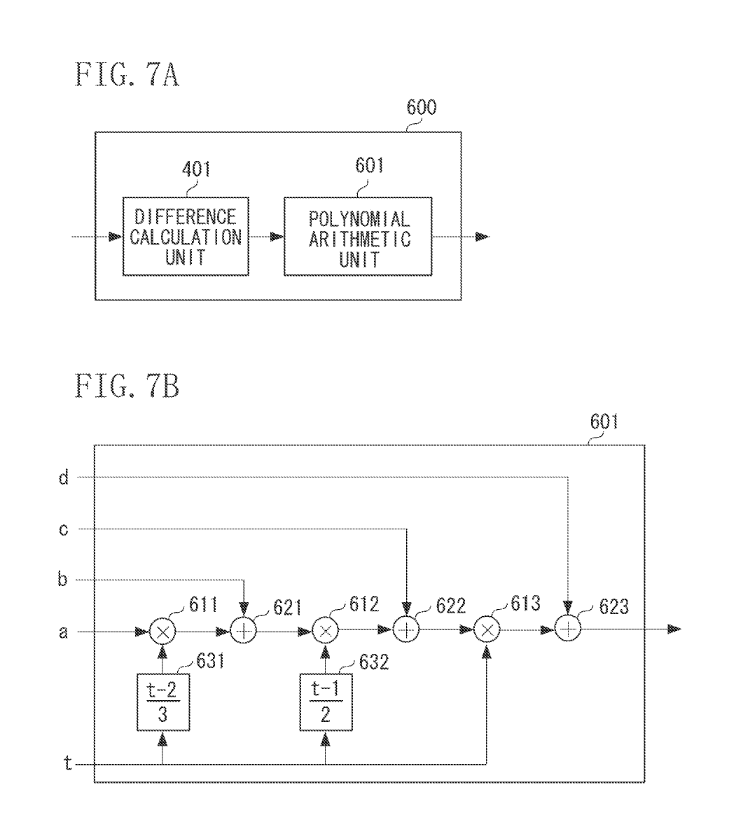

In the present modification, an interpolation arithmetic unit 600 illustrated in FIG. 7A replaces the interpolation arithmetic units 501 and 502 in FIG. 6.

In a case where interpolation is performed by calculating a polynomial, it is not necessary to adjust the forward step of a forward addition operation. Therefore, the forward difference adjustment unit and the forward addition arithmetic unit become unnecessary, and a polynomial arithmetic unit 601 illustrated in FIG. 7B is added in place of these units. The polynomial arithmetic unit 601 includes multipliers 611 to 613 and adders 621 to 623 for calculating the polynomial represented by the expression (2). This makes it possible to calculate the above-described intermediate data within a few cycles. In the interpolation in the horizontal direction in the subsequent stage, interpolation values are sequentially generated and therefore, the interpolation arithmetic unit 400 described in the first exemplary embodiment can be used as it is

A third exemplary embodiment will be described below. In general, in a case where two-dimensional processing is performed in hardware, it is often desirable to reduce the number of reference data pieces in the vertical direction and the order of a polynomial. For example, in a case where two-dimensional filter processing is performed, if the number of reference data pieces (the number of filter taps) in the vertical direction increases, high-cost line memories increase. Further, in the above-described exemplary embodiment, if the order number of the interpolation polynomial increases, the number of high-cost multipliers increases. Therefore, to reduce the cost of hardware, the processing in the vertical direction is often simplified.

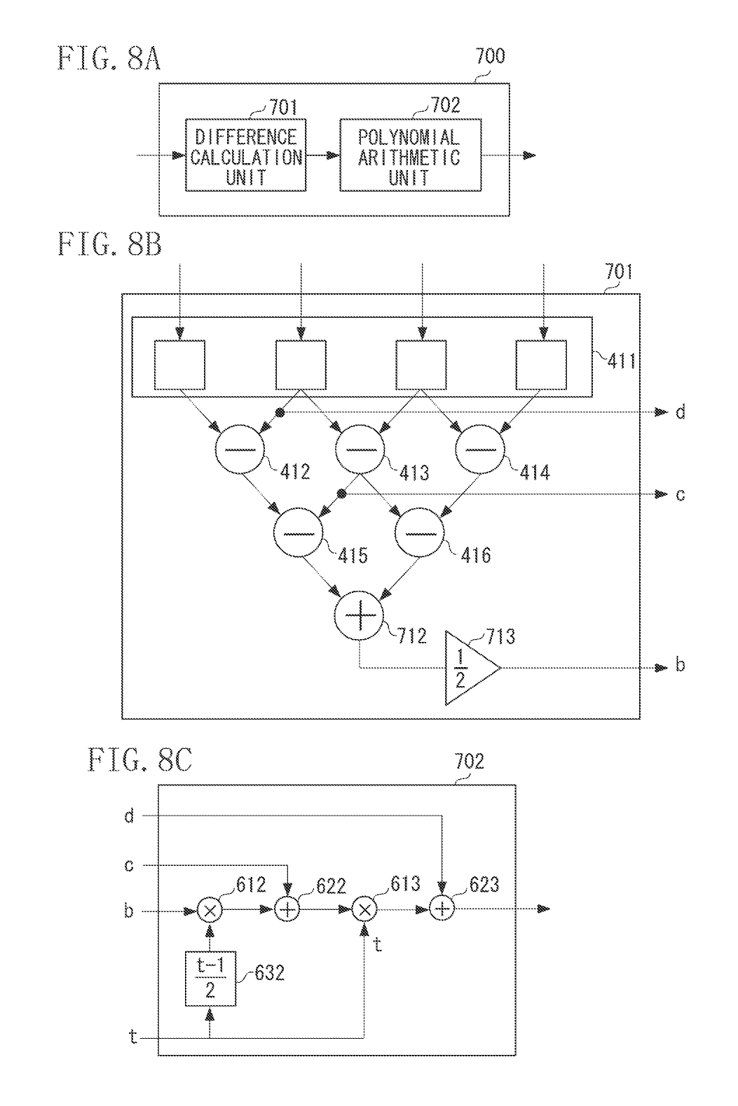

From such a view point, the interpolation degree may be reduced from third to second, in order to reduce the number of multipliers, in the modification of the second exemplary embodiment. In the present exemplary embodiment, such a configuration will be described below. FIGS. 8A to 8C illustrate a configuration of an interpolation arithmetic unit according to the present exemplary embodiment.

In a case where the interpolation order number is reduced to second, two cases are conceivable for the number of reference data pieces. One is a case where three pieces are referred to as a minimal number of data pieces, and the other is a case where four pieces are referred to in order to maintain symmetry of interpolation processing.

In the case where the number of reference data pieces is three, differences up to a second difference are calculated from these three reference data pieces, and three values are used as a forward difference parameter. It is included in various arithmetic circuits described before, so that it is not necessary to describe a new arithmetic circuit separately. As data to be referred to, one more data piece is used in addition to two data pieces at both ends of an interpolation section. An interpolation result leans to one side depending on whether the one more data is referred to from the starting point side or the endpoint side.

In contrast, in the case where the number of reference data pieces is four, an interpolation operation without the above-described leaning can be performed by generating a forward difference parameter that reflects these four reference data pieces.

Therefore, in the present exemplary embodiment, a divider 713 determines an average value of two second differences obtained from the four reference data pieces, which is used as a forward difference parameter b.

In one embodiment, the starting point and the endpoint of the reference data match with each other, and the starting point and the endpoint of the interpolation values match with each other. Therefore, it is naturally determined that of the forward difference parameters in the second degree interpolation, the starting point reference data is taken as the zero-th difference and the difference between the starting point and the endpoint reference data is taken as the first difference.

A parameter that reflects the four reference data pieces without leaning can be obtained by determining the remaining second difference in the manner described above.

While the exemplary embodiments have been described in detail, the disclosure may be applied to a system including a plurality of devices, or may be applied to an apparatus including a single device. Further, an exemplary embodiment of the disclosure can be implemented by a circuit (e.g., an application-specific integrated circuit (ASIC)) that implements one or more functions.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2017-013240, filed Jan. 27, 2017, which is hereby incorporated by reference herein in its entirety.

What is claimed is:

1. A device comprising:
a calculation unit configured to calculate difference data up to a predetermined stage with respect to a plurality of reference data;
a selection unit configured to select a forward difference parameter from the reference data and the difference data;
an adjustment unit configured to adjust the forward difference parameter to segment a corresponding forward step width; and
an arithmetic unit configured to determine interpolation data for the plurality of reference data, by performing a forward addition operation based on the adjusted forward difference parameter.

2. The device according to claim 1, wherein the selection unit selects each reference parameter from the plurality of reference data, and from difference data of each stage.

3. The device according to claim 1, wherein the selection unit selects the reference parameter based on second data in ascending order of magnitude, from the plurality of reference data.

4. The device according to claim 1, wherein, in a case where a number of the plurality of reference data is n+1, the calculation unit calculates difference data from a first difference to an n-th difference, n being a positive integer number.

5. The device according to claim 1, wherein the plurality of reference data corresponds to four grid points arranged on one axis, and the interpolation data corresponds to a position between two inner grid points of the four grid points.

6. The device according to claim 1, wherein the plurality of reference data are respective conversion coordinates of a plurality of specific coordinates, and the interpolation data is a conversion coordinate of a coordinate between the plurality of specific coordinates.

7. The device according to claim 1, wherein the arithmetic unit determines a conversion coordinate of a coordinate shifted forward by one each time the arithmetic unit performs a forward addition operation, and determines the conversion coordinate of a target coordinate by repeating the forward addition operation.

8. The device according to claim 1, wherein the adjustment unit performs segmentation by converting the forward difference parameter based on a predetermined matrix.

9. The device according to claim 8, wherein the adjustment unit repeats the conversion by the matrix.

10. The device according to claim 9, wherein the adjustment unit halves a forward step by performing the conversion once by the matrix.

11. The device according to claim 8, wherein each coefficient of the matrix is 0 or a power of 2, and the adjustment unit executes a multiplication of the coefficient by a bit shift.

12. The device according to claim 11, wherein the adjustment unit executes the conversion by the matrix, using a register and a subtracter.

13. The device according to claim 12, wherein the arithmetic unit performs a forward addition operation of data held in the register, and shares the register with the adjustment unit.

14. The device according to claim 1, wherein, for a plurality of two-dimensional data, data interpolation of a component of each axis is sequentially performed with the plurality of reference data.

15. A device that interpolates an area within 2×2 grid points at a center portion in a vertical direction and a horizontal direction, by referring to reference data corresponding to two-dimensionally arranged N×M grid points (N and M each being positive integer number), the data interpolation device comprising:
a first interpolation unit configured to perform data interpolation for each of N reference data in the vertical direction; and
a second interpolation unit configured to perform data interpolation in the horizontal direction by using the device according to claim 1, for M results of the data interpolation performed in the vertical direction.

16. The device according to claim 15, wherein the first interpolation unit includes
a second calculation unit that calculates difference data up to a predetermined stage with respect to a plurality of reference data, and
a unit that calculates an interpolation polynomial that uses a part of the difference data and the reference data as a parameter.

17. An apparatus that performs geometrical conversion on an image, the apparatus comprising:
an image storage unit configured to store an image;
a coordinate storage unit configured to store a plurality of conversion coordinates resulting from the geometrical conversion for a plurality of specific coordinates;
a coordinate conversion unit configured to determine a conversion coordinate of a target coordinate, by reading respective conversion coordinates of a plurality of coordinates near the target coordinate among the plurality of specific coordinates, from the coordinate storage unit, and interpolating the read conversion coordinates using the device according to claim 1; and
a conversion unit configured to perform geometrical conversion of an image, by associating a pixel corresponding to the target coordinate in the stored image, with the determined conversion coordinate.

18. A method comprising:
calculating difference data up to a predetermined stage with respect to a plurality of reference data;
selecting a forward difference parameter from the reference data and the difference data;
adjusting the forward difference parameter to segment a corresponding forward step width; and
determining interpolation data for the plurality of reference data, by performing a forward addition operation based on the adjusted forward difference parameter.

19. The method according to claim 18, wherein the selecting selects each reference parameter from the plurality of reference data, and from difference data of each stage.

20. The method according to claim 18, wherein the selecting selects the reference parameter based on second data in ascending order of magnitude, from the plurality of reference data.
